(19) United States
(12) Patent Application Publication
(10) Pub. No.: US 2014/0146978 A1
(43) Pub. Date: May 29, 2014

(54) EARPHONE ARTICLE WITH JEWELRY ATTACHMENT MEANS

(71) Applicant: DAVID & YOUNG GROUP CORP., Secaucus, NJ (US)

(72) Inventor: JOHN YOO, Secaucus, NJ (US)

(73) Assignee: David & Young Group Corp., Secaucus, NJ (US)

(21) Appl. No.: 13/688,476

(22) Filed: Nov. 29, 2012

(51) Int. Cl. H04R 1/10

(52) U.S. Cl. CPC H04R 1/10
USPC 381/74

(57) ABSTRACT

An earphone article is provided including an earbud body including a speaker and at least one neck portion. An attachment means including at least one aperture is disposed in each of the at least one neck portion. A jewelry piece is affixed to the at least one aperture.

### TECHNICAL FIELD

The present disclosure generally relates to an earphone article, and more to a combination earphone article with jewelry attachment means which can provide cold weather protection of the ears as well as improved acoustic sound functionality.

### BACKGROUND

Headsets and earphones are used to play audio such as music or voice via a device which can be fitted to the head or inserted into the ear canal. Conventional headsets and earphones may hold speakers to a user's outer ears and may be connected via a wire or wirelessly to a signal source such as an audio amplifier, radio, computer, CD player, MP3 player or other media player or listening device.

There are numerous types of earphones depending on the listening situation and needs of the individual user, including circumaural, supra-aural, earbud style and in-ear or canal phones. Different shapes and sizes of the earphones may be provided for fitting over and into the ears. Regardless of style, because earphones rest on the outside of the ear, they are typically easily visible to others when worn.

Wearing jewelry such as earrings is commonplace. However, many people do not wish to pierce their ears, or suffer from irritation or infection of existing pierced earlobes. Further, many types of earrings may be heavy to wear and present a risk of injury to the user's earlobes.

It would be desirable to provide an earphone device which can combine audio functionality with aesthetic appeal in a safe and flexible manner.

### SUMMARY

Accordingly, an earphone article with attachment means for jewelry is provided.

In one embodiment, an earphone article is provided comprising an earbud body including at least one neck portion and at least one attachment means disposed in the at least one neck portion.

In another embodiment, an earphone article is provided comprising an earbud body including a speaker and at least one neck portion; at least one attachment means disposed in each of the at least one neck portion; and a jewelry piece affixed to the at least one attachment means.

In yet another embodiment, an earphone article is provided comprising an earbud body including a speaker and at least one neck portion; at least one aperture disposed in each of the at least one neck portion; and a jewelry piece affixed to the at least one aperture.

These and other aspects, features and advantages of the present disclosure will be described or become apparent from the following detailed description, which is to be read in connection with the accompanying drawings.

### BRIEF DESCRIPTION OF THE DRAWINGS

The present disclosure will become more readily apparent from the specific description accompanied by the following drawings, in which:

FIG. 1 is a rear view of one embodiment of a pair of earphone articles with jewelry attachment means in an attached accessory mode in accordance with the principles of the present disclosure;

FIG. 2 is a rear view of one of the pair of earphone articles of FIG. 1 in accordance with the principles of the present disclosure;

FIG. 3 is a rear view of one of the pair of earphone articles of FIG. 1 having attachment means with no jewelry attached in accordance with the principles of the present disclosure;

FIG. 4 is a side perspective view of the earphone article of FIG. 3 in accordance with the principles of the present disclosure;

FIG. 5 is a side perspective view of the earphone article of FIG. 2 in accordance with the principles of the present disclosure;

FIG. 6 is a front perspective view of the earphone article of FIG. 3 in accordance with the principles of the present disclosure;

FIG. 7 is a side perspective view of an earphone article with attachment means according to an alternate embodiment;

FIG. 8 is a rear perspective view of an earphone article with attachment means according to an alternate embodiment;

FIG. 9 is rear perspective view of an earphone article with attachment means according to an alternate embodiment;

FIG. 10 is rear perspective view of an earphone article with attachment means according to an alternate embodiment;

FIG. 11 is rear perspective view of an earphone article with attachment means according to an alternate embodiment;

FIG. 12 is a rear view of an earphone article with attachment means according to an alternate embodiment; and

FIG. 13 is a rear view of an earphone article with attachment means according to an alternate embodiment.

Like reference numerals indicate similar parts throughout the figures.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION OF PREFERRED EMBODIMENTS

The exemplary embodiments of the earphone article with attachment means and related methods of use disclosed are discussed in terms of wearable accessories, to provide aesthetic appeal to the user's ears in an attachment mode as well as acoustic functionality.

It is envisioned that the earphone article and method may be employed with additional devices, features and/or methods for providing additional functionality such as, volume control, sound quality and effects, and the like. Furthermore, the earphone article may be connected to a signal source via a wire and/or wirelessly.

The present disclosure may be understood more readily by reference to the following detailed description of the disclosure taken in connection with the accompanying drawing figures, which form a part of this disclosure. It is to be understood that this disclosure is not limited to the specific devices, methods or parameters described and/or shown herein, and that the terminology used herein is for the purpose of describing particular embodiments by way of example only and is not intended to be limiting of the claimed disclosure. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior”.

The following discussion includes a description of an earphone article with attachment means and related methods of using same in accordance with the principles of the present disclosure. Alternate embodiments are also disclosed. Reference will now be made in detail to certain exemplary embodiments of the present disclosure, examples of which are illustrated in the accompanying figures. While the application will be described in conjunction with the illustrated embodiments, it will be understood that they are not intended to limit the application to those embodiments. On the contrary, the application is intended to cover all alternatives, modifications, and equivalents, which may be included within the application as defined by the appended claims.

The headings below are not meant to limit the disclosure in any way; embodiments under any one heading may be used in conjunction with embodiments under any other heading.

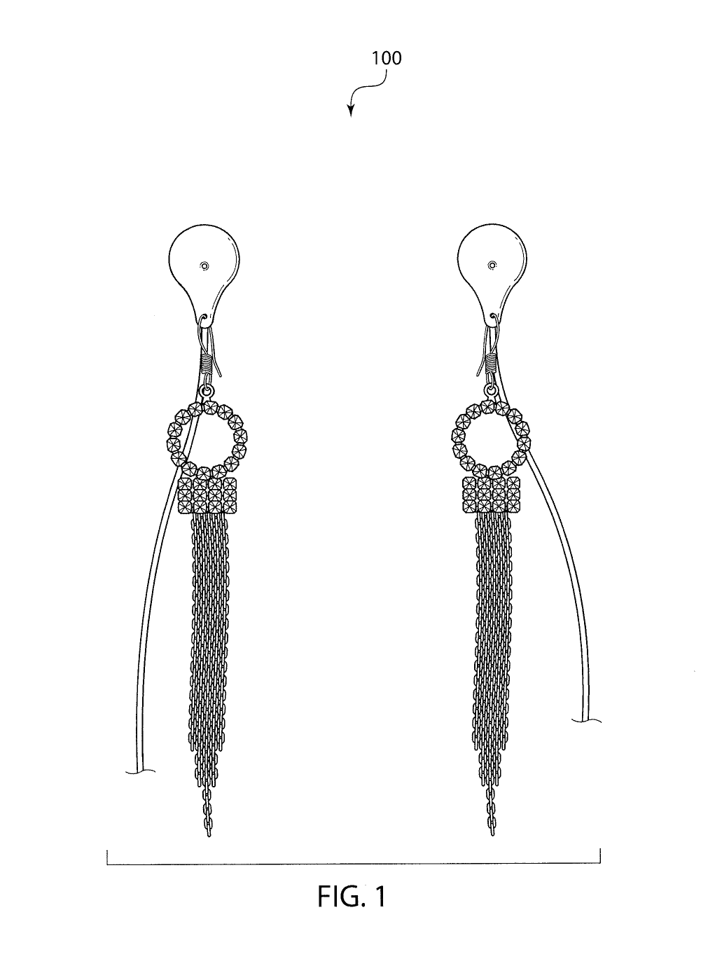

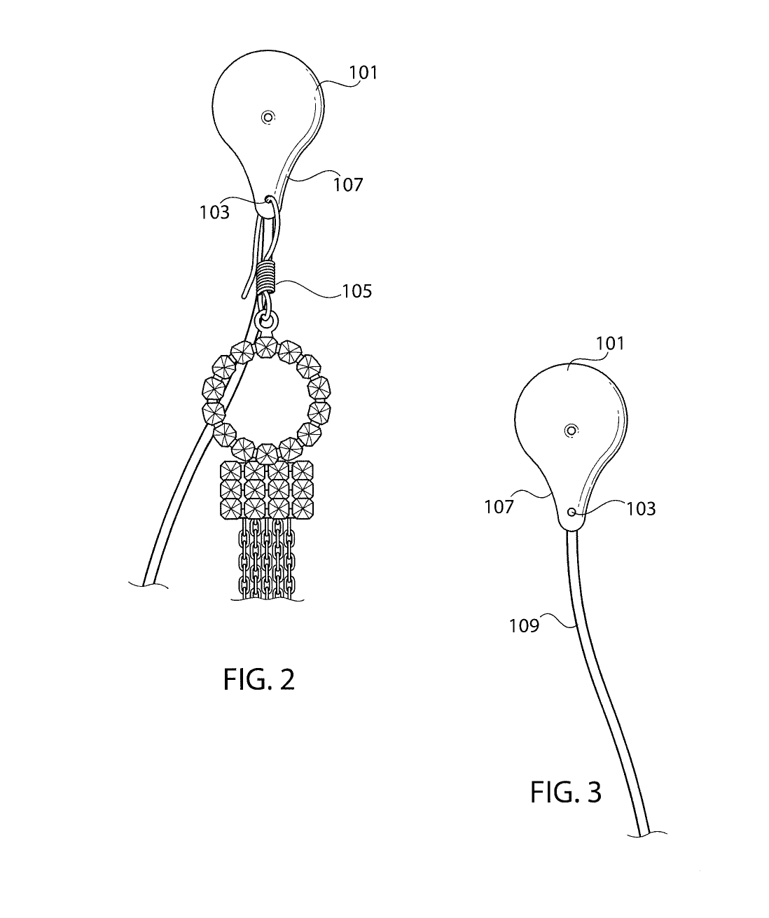

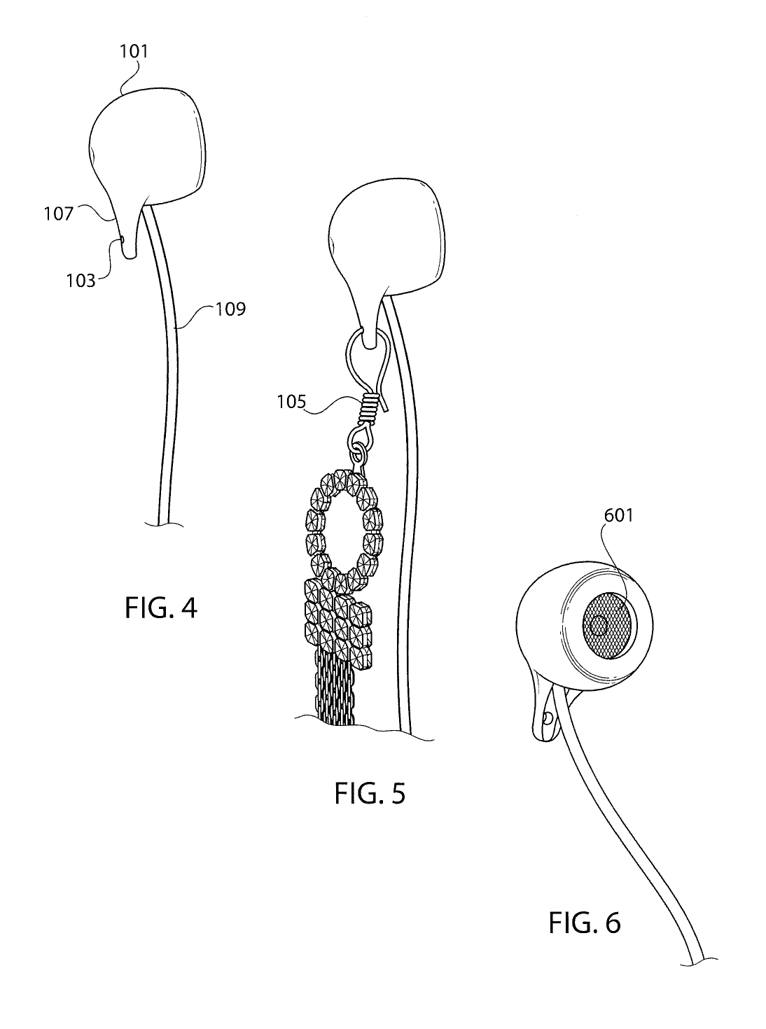

Turning now to FIGS. 1-13, there are illustrated components of an earphone article in accordance with principles of the present disclosure.

A pair of earphone articles 100 with attachment means is depicted in FIG. 1. In use, two earphone articles 100 are preferably used together for listening to sound in stereo without disturbing others. The earphone article 100 may comprise an earphone or earbud body 101 including a neck portion 107. The neck portion 107 may comprise an elongate portion protruding from a lower end of the earbud body 101. The neck portion 107 may nr may not be integrally formed with the earbud body 101. Alternate shapes, configurations and sizes of the neck portion 107 may be contemplated.

The earbud body 101 is preferably configured to be inserted within a user's ear canal to project sound into the ear canal. While a substantially tubular shape of the earbud body 101 is shown, it is contemplated that the earbud body 101 may be provided in any configuration or shape and/or be customized in a mold to facilitate and improve a secure and comfortable fit within the user's ear canal.

The earbud body 101 preferably houses a speaker 601 and electrical components (not shown) which, e.g., in a wired embodiment, as shown in FIGS. 1-11, may be functionally connected via a wire 109 to a signal source (not shown), such as an audio amplifier, radio, computer, CD player, MP3 player or other media player or listening device. In alternate embodiments, the earphone 100 may be provided in a wireless embodiment in which no cord 109 is necessary. The details of the speaker 601 and electrical components, whether in wired or wireless embodiments, are known by one of ordinary skill in the art and any omission of same herein is not to be interpreted as limiting.

Optionally, the earbud body 101 may comprise a housing only, with no speaker or audio functionality.

The components of an earphone article 100 may be fabricated from any substantially rigid and/or flexible materials, including metals, synthetic polymers, polymeric materials, plastics, rubber, carbon fiber, wood and/or their composites and combinations thereof, depending on the properties desired. Various components of the earphone article with attachment means 100 may have material composites, including the above materials, to achieve various desired characteristics such as strength, rigidity, resiliency, elasticity and/or durability. In various embodiments, the components of the earphone article 100 may each be monolithically formed and integrally connected.

The earbud body 101 may include one or more attachment means 103 which, in an exemplary embodiment, may be positioned at or substantially near a distal end of the neck portion 107. The attachment means 103 may comprise, e.g., at least one aperture or hole formed to pass through the neck portion 107, e.g., to pass through the neck portion 107 entirely from front to back. The aperture 103 may comprise any shape and/or diameter. While a single aperture 103 and a single neck portion 107 are shown herein in FIGS. 1-11 for exemplary purposes, it is contemplated that a plurality of apertures/neck portions may be provided formed in any location of the earbud body 101 and in any arrangement.

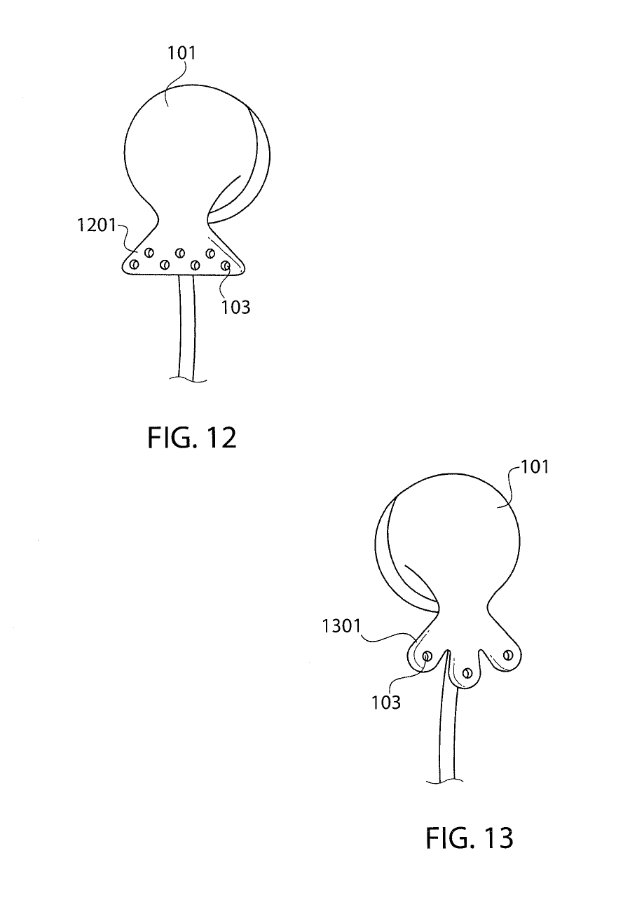

To illustrate, FIGS. 12 and 13 depict exemplary alternate embodiments of an earbud body 101. For example, the embodiment of FIG. 12 depicts a fan-shaped neck portion 1201 which includes a plurality of apertures 103 formed to pass through in a staggered arrangement. In another exemplary embodiment, FIG. 13 depicts a plurality of neck portions 1301 comprised of a plurality of finger-like projections jutting from a lower portion of the earbud body 101, each of the neck portions 1301 including at least one aperture 103.

Each earphone article is shown with an attached jewelry piece 105, e.g., in the form of an earring. The jewelry piece 105 may comprise a drop earring having a hook inserted into the aperture 103. Accordingly, once attached, the earring is effectively attached to the earbud body 101. The depiction of an earring presented herein is for exemplary purposes only and is not intended to be limiting. The jewelry piece may comprise any type of jewelry or article in any alternate shape, design or configuration. For example, jewelry may comprise a stud earring having a post inserted through and affixed to the attachment means 103.

Each earbud body 101 with attached jewelry 105 may be inserted into the ear to provide audio functionality together with a decorative and aesthetic fashionable effect, namely the appearance that the user is wearing earrings. Advantageously, the jewelry is easily interchangeable and the user can essentially ‘wear’ earrings having hooks or posts without requiring piercings in their earlobes. Further, a user can adorn their ears with jewelry, even heavy pieces of jewelry, without concern for potential injury to the earlobe in the event the earring is snagged or pulled accidentally. Indeed, if the jewelry is caught and pulled, the earbud 101 will simply be caused to fall out of the ear, preventing injury to the user.

Moreover, a user who may have pierced earlobes but is suffering an irritation or infection of the pierced areas, can still adorn give the appearance of adorning their ears with jewelry without aggravating the infected lobes. Particularly, costume jewelry having posts or hooks not coated with or made of precious metals such as gold or silver, often cause irritation to many users with sensitive earlobes.

An earphone article according to the present principles advantageously enables users to safely and comfortably enjoy the appearance of wearing any type of earring, regardless of weight or material, while also optionally enjoying audio features of earphones.

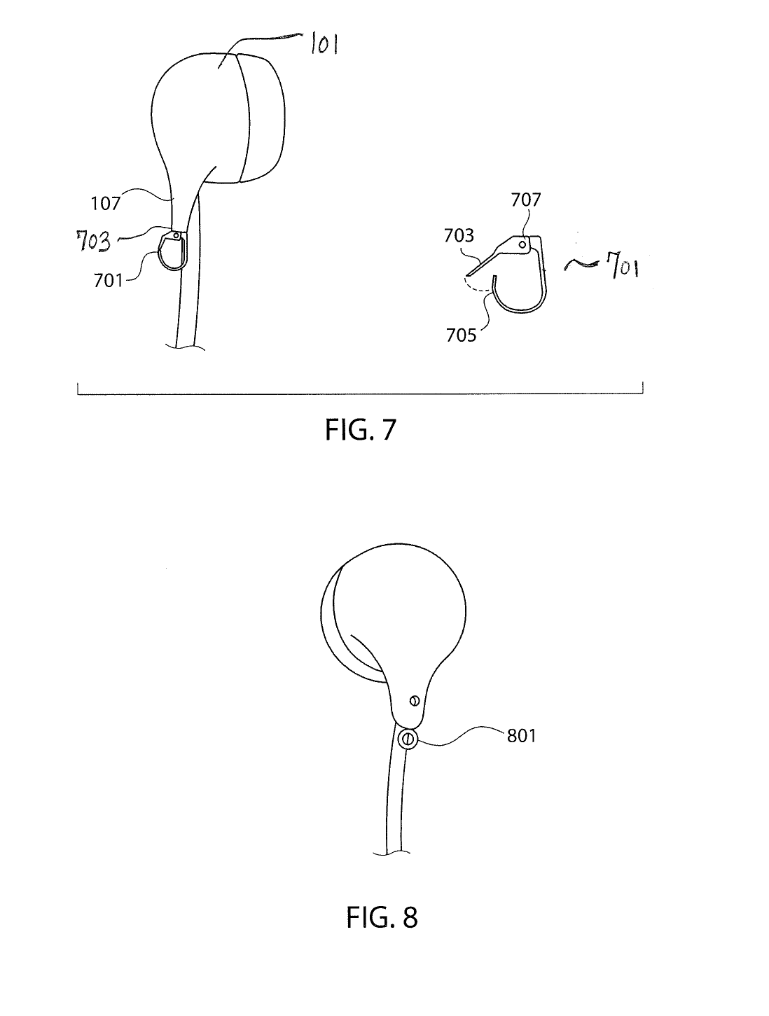

Alternate embodiments of the earphone article 100 may be contemplated, such as those shown in FIGS. 7-11, which depict views of alternate embodiments of an earphone article in accordance with the principles of the present disclosure.

In one exemplary embodiment as shown in FIG. 7, the earbud body 101 comprises a neck portion 107 having a clasp 701 affixed to a tip 703 of the distal end of the neck portion 107. The clasp 701 may comprise a hinge portion 707 which preferably includes a substantially flat top surface for facilitating attachment to the tip 703. The clasp 701 may further include a movable lever 703 and a hook member 705. Objects such as jewelry or other decorative items may be attached to the clasp 701 and the earbud 101 may be worn by a user to achieve both acoustic functionality and an ornamental and aesthetic effect.

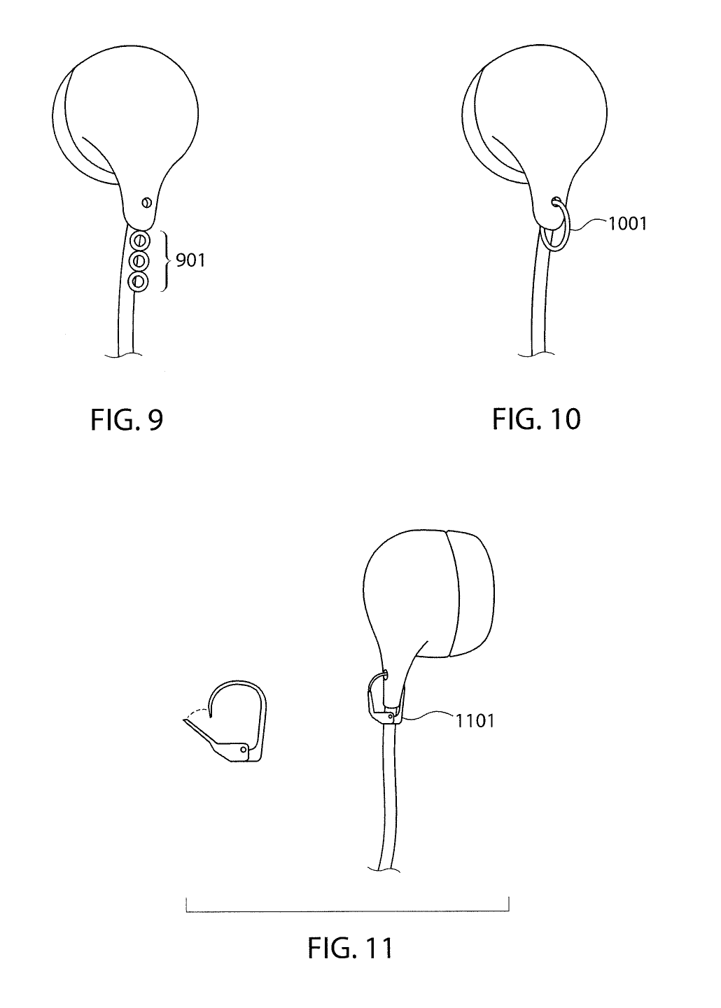

In another exemplary embodiment as shown in FIGS. 8-9, one or more loops 801, 901 may be provided affixed to the tip 703 of the distal end of the neck portion 107. The loops 801, 901 may be circular or comprise any other shape and configuration or size, and are configured to enable attachment of objects such as jewelry. In embodiments having a plurality of loops, the loops may be in any arrangement, e.g., to form linear (as shown in FIG. 9), circular or polygonal shapes, etc.

In yet another exemplary embodiment as shown in FIGS. 10-11, the attachment means 103 of the neck portion 107 may include a permanent or removable loop 1001 or clasp 1101 affixed thereto. An object such as a jewelry piece may be attached to the loop 1001 or clasp 1101.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

What is claimed is:

1. An earphone article comprising:
an earbud body including at least one neck portion; and
at least one attachment means disposed in the at least one neck portion.

2. The article of claim 1, wherein the at least one neck portion comprises at least one elongate portion protruding from a lower end of the earbud body.

3. The article of claim 1, wherein the earbud body includes a speaker.

4. The article of claim 1, wherein the at least one attachment means is disposed at a distal end of the neck portion.

5. The article of claim 1, further comprising a jewelry piece affixed to the at least one attachment means.

6. The article of claim 1, wherein the at least one attachment means comprises at least one aperture.

7. The article of claim 6, further comprising an earring having at least one of a hook or post insertably affixed within the aperture.

8. An earphone article comprising:
an earbud body including a speaker and at least one neck portion;
at least one attachment means disposed in each of the at least one neck portion; and
a jewelry piece affixed to the at least one attachment means.

9. The article of claim 8, wherein the at least one attachment means comprises at least one aperture.

10. The article of claim 8, further comprising at least one loop or clasp affixed to a tip of the neck portion.

11. The article of claim 8, further comprising a plurality of loops affixed to a tip of the neck portion.

12. The article of claim 11, further comprising a jewelry piece affixed to at least one of the plurality of loops.

13. The article of claim 8, wherein the at least one attachment means comprises a plurality of apertures formed in the at least one neck portion.

14. The article of claim 13, wherein the plurality of apertures are in a staggered arrangement.

15. The article of claim 13, wherein the at least one neck portion is fan-shaped.

16. The article of claim 8, wherein the at least one neck portion comprises a plurality of finger-shaped projections jutting from a lower portion of the earbud body.

17. An earphone article comprising:
an earbud body including a speaker and at least one neck portion;
at least one aperture disposed in each of the at least one neck portion; and
a jewelry piece affixed to the at least one aperture.

18. The article of claim 17, further comprising at least one loop or clasp affixed to a tip of the neck portion.

19. The article of claim 17, further comprising a plurality of loops affixed to a tip of the neck portion.

20. The article of claim 17, wherein the at least one neck portion comprises a plurality of finger-shaped projections jutting from a lower portion of the earbud body.
